(19) United States
(12) Patent Application Publication
(10) Pub. No.: US 2012/0161658 A1
(43) Pub. Date: Jun. 28, 2012

(54) SOLAR SIMULATOR

(75) Inventor: Seiji Yoshino, Ehime-ken (JP)

(73) Assignee: NPC INCORPORATED, Toyko-To (JP)

(21) Appl. No.: 13/139,800

(22) PCT Filed: Dec. 20, 2010
(86) PCT No.: PCT/JP2010/072907

§ 371 Date: Mar. 12, 2012

(30) Foreign Application Priority Data
Dec. 28, 2009 (JP) 2009-297836

(51) Int. Cl. H05B 37/02

(52) U.S. Cl. 315/226

(57) ABSTRACT

A solar simulator includes a flash lamp 103 for radiating light to a solar battery module, a power supply 101 for supplying a current to the flash lamp, switch units 105a to 105c connected in parallel for causing a current to be supplied to the flash lamp when turned on and causing a current to the flash lamp to be shut off when turned off, ballast resistors 106a to 106c interposed between the switch units and the power supply, and a control unit 102 for performing an on/off control of the switch units and sequentially switching a switch unit to be turned on at every predetermined time, prevents thermal destruction of the semiconductors included in the switch units due to a temperature increase. Then, a constant current can be caused to continuously flow through the flash lamp 103 and can be caused to emit light for a long time.

### TECHNICAL FIELD

The invention relates to a solar simulator for radiating pseudo solar light to a solar battery module as a target whose performance is examined.

### BACKGROUND ART

In an examination of an electric performance of a solar battery, output characteristics of a solar battery when pseudo solar light is radiated from a pseudo solar light radiation apparatus (solar simulator) is measured. As the solar simulator, for example, a long-arc xenon flash lamp employing a simple capacitor system has come into practical use (for example, refer to Nonpatent Document 1).

The flash lamp employing the capacitor system applies a high voltage to outside of a tube of a low pressure long-arc xenon lamp by connecting a charged capacitor to the long-arc xenon lamp, generates a discharge plasma by field-emitted electrons from an internal cold cathode electrode and is caused to emit light by discharging a charge of the capacitor by plasma.

With the operation, a total light emission amount can be easily controlled only by energy of the capacitor and a circuit is simplified. The charge of the capacitor is reduced by discharge, and irradiance is also lowered exponentially as a time passes. Accordingly, although a constant amount of irradiance is not obtained, when the irradiance is limited to a narrow range of a decreasing function, a change of irradiance can be corrected by providing a means for monitoring the irradiance. Thus, the capacitor system flash lamp is used often for a performance examination of a silicon crystal solar battery module to which irradiance of 1 kw (±20%) and a measurement time of about 2 milliseconds are required.

In contrast, a response speed of a thin film type solar battery, which is low in price and suitable for a large amount production, is slower than that of a silicon crystal solar battery, a flash lamp that is a light source of a solar simulator is required to emit light for about 10 milliseconds to 100 milliseconds in stable irradiance.

Accordingly, there is proposed a solar simulator for driving a lamp current by connecting a low-pass filter composed of a coil and an inductor in a multi-stage so that flash light keeps stable irradiance for 4 milliseconds to 20 milliseconds (refer to, for example, Patent Document 1). However, in the method, respective elements have a large loss. Further, since a circuit element is composed of a custom-order part and many switch circuits are necessary, there is a problem that the cost increases.

To stably control irradiance of a flash lamp while reducing a circuit scale and a cost, it is considered effective to drive a lamp by a constant current pulse using a switch circuit that uses an active region of a semiconductor. However, when a flash lamp is emitted for a long time to properly measure a performance of a solar battery having a slow response speed, there is a possibility that thermal destruction occurs due to excessive power because a large amount of power is consumed by a semiconductor that constitutes the switch circuit and thus it is difficult to guarantee reliability of an apparatus.

### PRIOR ART DOCUMENT

### Patent Document

Patent Document 1: Japanese Patent Application Laid-Open No. 2007-88419

### Nonpatent Document

Non-Patent Document 1: Optical technology magazine “Light Edge” featured in discharge lamp, Ushio Inc. No. 15, November 1998

### DISCLOSURE OF THE INVENTION

### Problems to be Solved by the Invention

An object of the invention is to provide a solar simulator capable of measuring output characteristics of a solar battery with a high accuracy even if the solar battery has a slow response speed.

### Means for Solving the Problems

A solar simulator according to a mode of the invention includes a flash lamp for radiating light to a solar battery module, a power supply for supplying a current to the flash lamp, 1st to n-th (n is an integer of 2 or more) switch units connected in parallel for causing a current to be supplied to the flash lamp when turned on and causing a current to the flash lamp to be shut off when turned off, a k-th ballast resistor interposed between the k-th (k is an integer satisfying 1≦k≦n) switch unit and the power supply, and a control unit for performing an on/off control of the 1st to n-th switch units and sequentially switching a switch unit to be turned on at every predetermined time.

A solar simulator according to a mode of the invention includes a flash lamp for radiating light to a solar battery module, a power supply for supplying a current to the flash lamp, a plurality of switch units connected in parallel for causing a current to be supplied to the flash lamp when turned on and causing a current to the flash lamp to be shut off when turned off, a ballast resistor interposed between a common connection point of the plurality of switch units and the power supply, and a control unit for performing an on/off control for causing the plurality of switch units to be turned on and off at a different timing.

### EFFECT OF THE INVENTION

According to the invention, output characteristics of the solar battery can be measured with a high accuracy regardless of a response speed of the solar battery.

### BRIEF DESCRIPTION OF THE DRAWINGS

FIG. 1 is a schematic configuration view of a solar simulator according to a first embodiment of the invention.

FIG. 2 shows graphs showing examples of changes of currents flowing through switch units.

FIG. 3 shows graphs showing examples of changes of temperatures of semiconductors included in the switch units.

FIG. 4 shows graphs showing examples of changes of currents flowing through the switch units.

FIG. 5 is a schematic configuration view of a solar simulator according to a comparative example.

FIG. 6 shows graphs showing examples of changes of temperatures of semiconductors included in switch units in the comparative example.

FIG. 7 is a schematic configuration view of a solar simulator according to a second embodiment of the invention.

FIG. 8 shows graphs showing examples of changes of currents flowing through switch units.

FIG. 9 is a schematic configuration view of a solar simulator according to a modification.

### MODES FOR CARRYING OUT THE INVENTION

Embodiments of the invention will be described below based on the drawings.

### First Embodiment

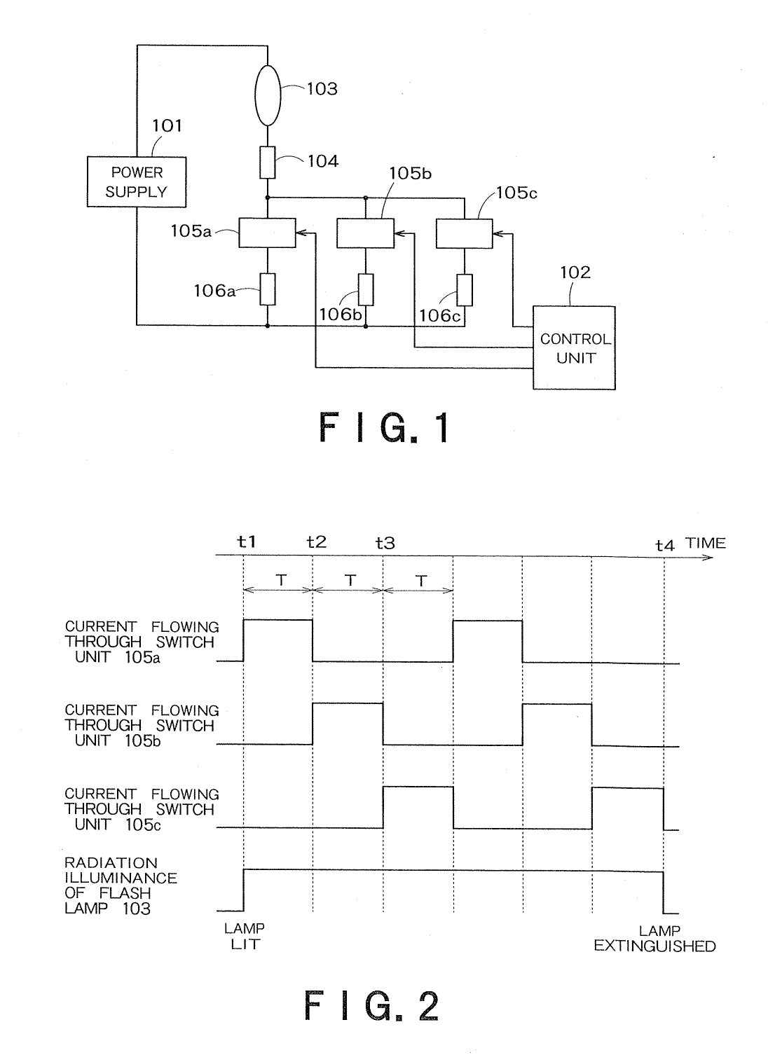

FIG. 1 shows a schematic configuration view of a solar simulator according to a first embodiment of the invention. The solar simulator includes a power supply 101, a control unit 102, a flash lamp 103, a power absorption unit 104, switch units 105a to 105c, and ballast resistors 106a to 106c.

The flash lamp 103 radiates pseudo solar light to a not shown thin film type solar battery module. An electric performance can be examined by detecting output characteristics of the thin film type solar battery module radiated with the pseudo solar light.

The power supply 101 supplies a current to the flash lamp 103. The control unit 102 performs an on/off control of the switch units 105a to 105c. The control unit 102 is, for example, a microcomputer. The switch units 105a to 105c are switch circuits each using a power semiconductor, for example, an insulated gate bipolar transistor (IGBT) and the like and have a feature of capable of supplying a constant current to a lamp because they are turned on in active regions based on a control command value of the control unit 102.

When at least one of the switch units 105a to 105c is turned on, a current flows through the flash lamp 103 and the flash lamp 103 is lit. When all the switch units 105a to 105c are turned off, no current flows through the flash lamp 103 and the flash lamp 103 is not lit.

The ballast resistors 106a to 106c are interposed between the switch units 105a to 105c and the power supply 101, respectively. The power absorption unit 104 is interposed between a common connection point of the switch units 105a to 105c and the flash lamp 103 and includes, for example, a resistor.

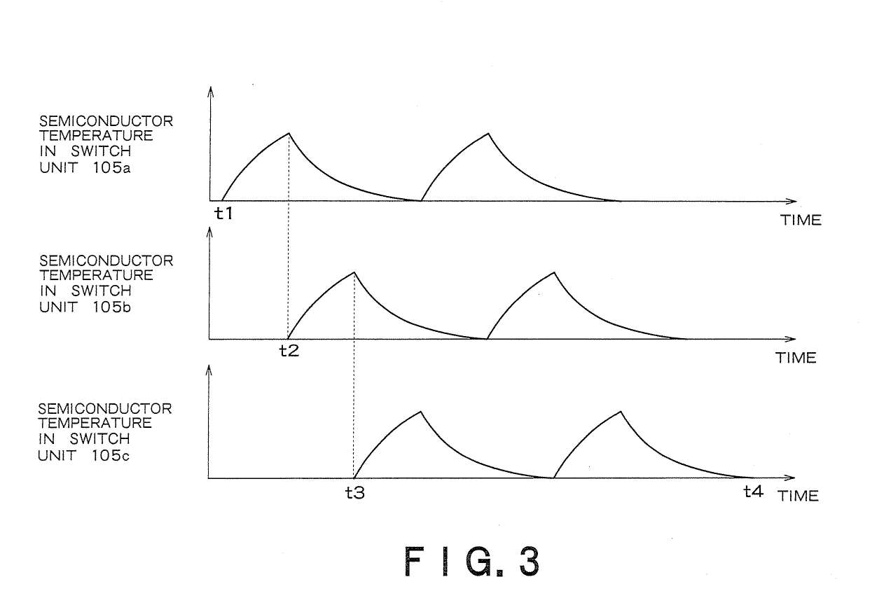

The on/off control of the switch units 105a to 105c performed by the control unit 102 will be described with reference to FIGS. 2 and 3. FIG. 2 shows examples of magnitudes of currents flowing through the switch units 105a to 105c and ideal changes of irradiance of the flash lamp 103. Further, FIG. 3 shows changes of temperatures of semiconductors (power semiconductors) that constitute the switch units 105a to 105c.

First, the control unit 102 turns on the switch unit 105a at time t1. At the time, the switch units 105b and 105c are turned off. With the operation, the current flows through the flash lamp 103 and the switch unit 105a, and the flash lamp 103 is lit.

Subsequently, the control unit 102 turns off the switch unit 105a and turns on the switch unit 105b at time t2. The current flows through the flash lamp 103 and the switch unit 105b, and the flash lamp 103 is continuously lit.

Subsequently, the control unit 102 turns off the switch unit 105b and turns on the switch unit 105c at time t3. The current flows through the flash lamp 103 and the switch unit 105c, and the flash lamp 103 is continuously lit.

Thereafter, the control unit 102 sequentially switches the switch units 105a to 105c to be turned on. A time T during which a switch unit is turned on is, for example, about 4 milliseconds. In FIG. 2, at time t4, all the switch units 105a to 105c are turned off, and the flash lamp 103 is extinguished.

As found from FIG. 3, temperatures of the semiconductors that constitute the switch units 105a to 105c increase when the semiconductors are turned on and decrease when they are turned off. The temperatures of the semiconductors that constitute the respective switch units do not become excessively high by switching the switch units 105a to 105c to be turned on.

With the configuration, the flash lamp 103 is supplied with a constant current for a long time without interruption, and thermal destruction due to temperature increase of the switch units 105a to 105c can be prevented. Since the flash lamp 103 stably emits light for a long time, output characteristics of a thin film type solar battery module having a slow response speed can be measured with a high accuracy.

Note that although FIG. 2 shows the ideal changes of magnitudes of the currents flowing through the switch units 105a to 105c, actually, a surge voltage is generated when the currents increase and decrease. Accordingly, it is preferable to measure the output characteristics of the thin film type solar battery module in a region (time band) in which light radiated from the flash lamp 103 is stable except a time at which the switch units are switched.

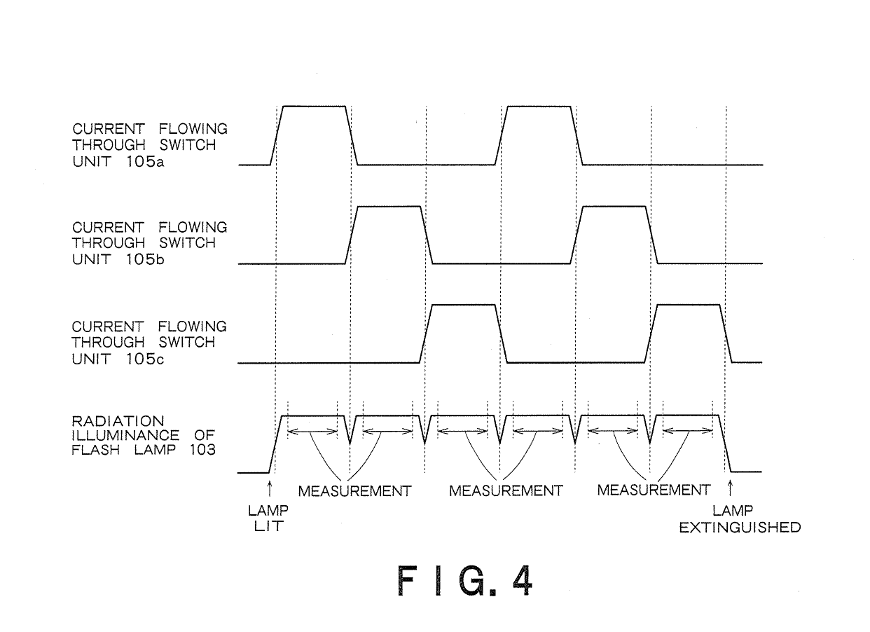

As shown in FIG. 4, an increase and a decrease of the currents may be provided with an inclination. With the configuration, a transient current is suppressed and thus generation of the surge voltage can be suppressed. Further, a variation of irradiance of the flash lamp 103 can be also suppressed. To change the inclination, for example, a current value of a current source connected through resistance to gate electrodes of input MOSFETs of the IGBTs that constitute the switch units 105a to 105c is changed.

Also in a case shown in FIG. 4, it is preferable to measure the output characteristics of the thin film type solar battery module in the region (time band) in which the light radiated from the flash lamp 103 is stable except the time at which the switch units are switched.

### Comparative Example

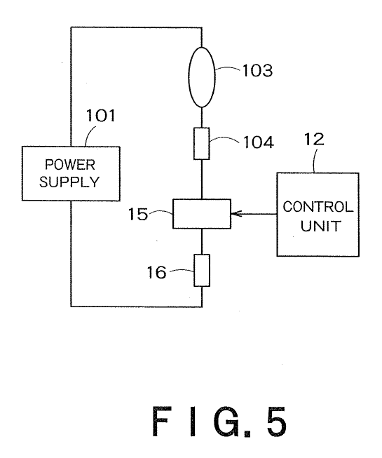

FIG. 5 shows a schematic configuration of a solar simulator according to a comparative example. The solar simulator includes a power supply 101, a control unit 12, a flash lamp 103, a power absorption unit 104, a switch unit 15, and a ballast resistor 16. The comparison example is different from the first embodiment shown in FIG. 1 in that one set of the switch unit is provided, and the same components are denoted by the same reference numerals and description thereof will not be repeated.

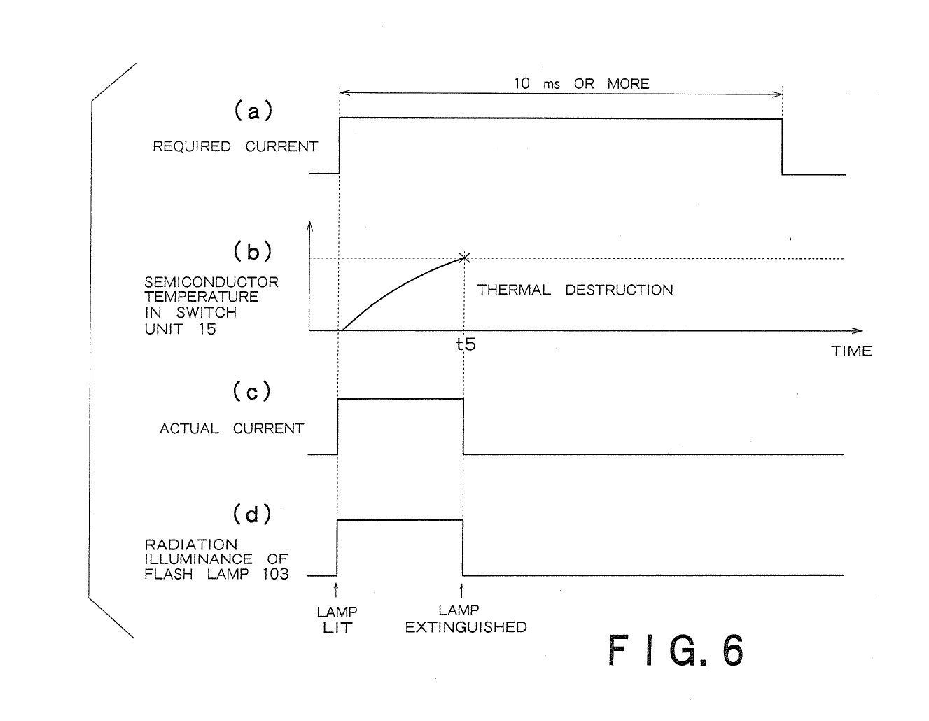

The control unit 12 performs an on/off control of the switch unit 15. The switch unit 15 is required to continuously flow a current for a long time (for example, 10 milliseconds or more) as shown in FIG. 6(a). However, as shown in FIG. 6(b), a temperature of a semiconductor that constitutes the switch unit 15 continuously increases and thermal destruction occurs at time t5.

Accordingly, a current flowing through the switch unit 15 and irradiance of the flash lamp 103 change as shown in FIGS. 6(c), and 6(d), respectively. The flash lamp 103 cannot emit light for a long time and thus output characteristics of a solar battery module having a slow response speed such as a thin film type solar battery module cannot be measured.

In contrast, in the first embodiment, since the plural switch units are disposed and the constant current is caused to continuously flow through the flash lamp 103 while switching a switch unit to be turned on, thermal destruction of the switch units can be prevented and the flash lamp 103 can be caused to emit light for a long time. The flash lamp 103 can be driven in a long-pulse for several hundreds of milliseconds.

### Second Embodiment

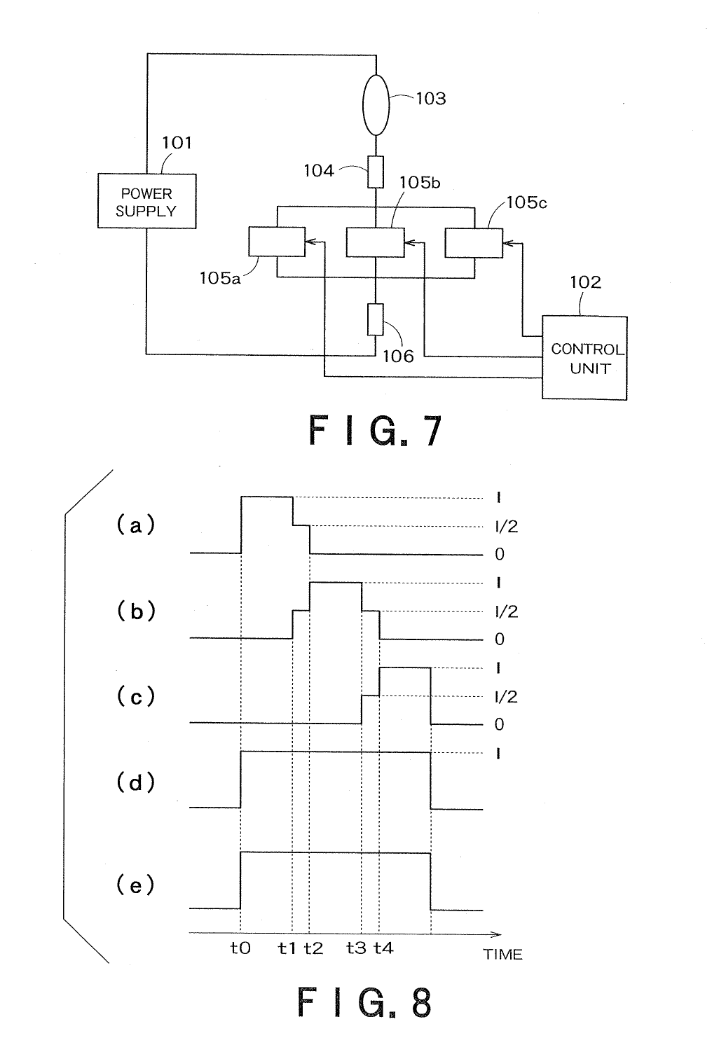

FIG. 7 shows a schematic configuration of a solar simulator according to a second embodiment of the invention. The solar simulator includes a power supply 101, a control unit 102, a flash lamp 103, a power absorption unit 104, switch units 105a to 105c, and a ballast resistor 106.

Although the plural ballast resistors 106a to 106c are disposed so as to correspond to the switch units 105a to 105c, respectively in the first embodiment shown in FIG. 1, in the embodiment, the common ballast resistor 106 is disposed.

Further, in the first embodiment, although the control unit 102 turns on the switch unit 105b at the same time the switch unit 105a is turned off, in the embodiment, the control unit 102 turns on the switch unit 105b at a predetermined time before a time at which the control unit 102 turns off the switch unit 105a. Likewise, the control unit 102 turns on the switch unit 105c at a predetermined time before a time at which the control unit 102 turns off the switch unit 105b, and the control unit 102 turns on the switch unit 105a at a predetermined time before a time at which the control unit 102 turns off the switch unit 105c.

FIGS. 8(a) to 8(c) show examples of changes of currents that flow through the switch units 105a to 105c. Further, FIG. 8(d) shows a change of a total value of currents flowing through the switch units 105a to 105c (current supplied to the flash lamp 103), and FIG. 8(e) shows a change of irradiance of the flash lamp 103.

At time t0, the switch unit 105a is turned on, and a current I flows through the switch unit 105a.

At time t1, the switch unit 105b is turned on. With the operation, a current flowing through each of the switch units 105a, 105b becomes ½. At time t2, the switch unit 105a is turned off, and a current flowing through the switch unit 105b becomes I.

At time t3, the switch unit 105c is turned on. With the operation, a current flowing through each of the switch units 105b, 105c becomes ½. At time t4, the switch unit 105b is turned off, and a current flowing through the switch unit 105c becomes I.

Times during which the respective switch units are turned on (between times t0 to t2, between times t1 to t4, and the like) are times during which semiconductors of the switch units are not thermally destructed and the times are, for example, about 4 milliseconds due to a temperature increase. Times during which two switch units are turned on at the same time (between times t1 to t2 and the like) may be short times and, for example, about 0.5 millisecond.

Also with the configuration, likewise the first embodiment, a constant current can be caused to continuously flow through the flash lamp 103 and can be caused to emit light for a long time while preventing thermal destruction of the switch units. Further, according to the embodiment, it can be suppressed that the current is changed as a times passes by turning on and off the switch units, thereby a variation of irradiance of the flash lamp 103 can be suppressed.

A configuration in which the three switch units are disposed is described in the first and second embodiments, it is sufficient that two or more switch units are disposed. The number of switch units is preferably determined in consideration of a heat resistant performance of the semiconductors that constitute the switch units, a lit-time of the flash lamp necessary to detect the output characteristics of the solar battery module, and the like.

In the first and second embodiments, although the control unit 102 performs the on/off control of the switch units 105a to 105c, the control unit 102 can suppress power consumed by the switch units by further controlling a power supply voltage and more effectively suppress thermal destruction of the semiconductors as the switches as well as keep a lamp current stable and increase reliability of the solar simulator. Further, the first and second embodiments can be configured to omit the power absorption unit 104.

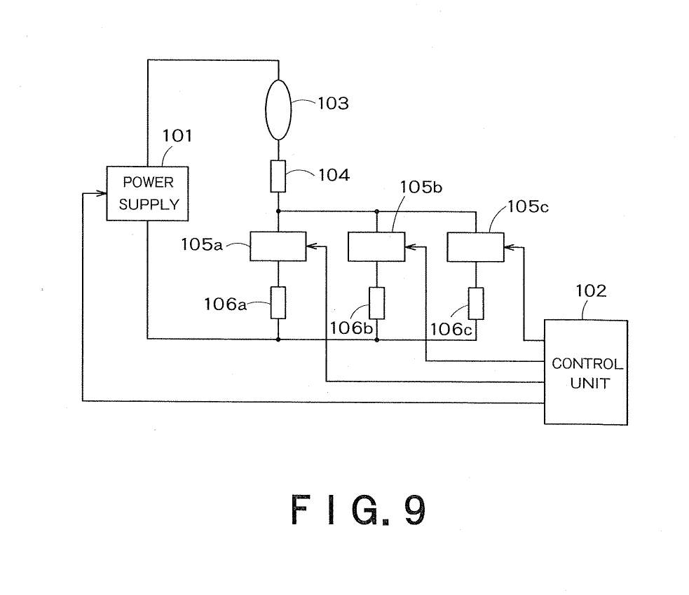

Specifically, as shown in FIG. 9, the control unit 102 performs the on/off control of the switch units 105a to 105c and controls a voltage of the power supply 101 based on a predetermined function for determining the power supply voltage. The predetermined function is a function for determining an optimum power supply voltage value using irradiance, a lamp current, a lamp lit-time (radiation time), and transient temperature increase values of the semiconductors that constitute the switch units as input parameters. The control unit 102 may control a voltage of the power supply 101 also like in a configuration shown in FIG. 7.

Note that the invention is not limited to the embodiments as they are and may be embodied by modifying components in a scope which does not depart from a gist of the invention. Further, various inventions can be formed by appropriately combining plural components disclosed in the embodiments. For example, some components may be deleted from all the components shown in the embodiments. Further, components of different embodiments may be appropriately combined.

### REFERENCE NUMERALS

101 power supply
102 control unit
103 flash lamp
104 power absorption unit
105a to 105c switch unit
106a to 106c ballast resistor

1. A solar simulator comprising:
a flash lamp which radiates light to a solar battery module;
a power supply which supplies a current to the flash lamp;
1st to n-th (n is an integer of 2 or more) switch units connected in parallel which cause a current to be supplied to the flash lamp when turned on and cause a current to the flash lamp to be shut off when turned off;
a k-th ballast resistor interposed between the k-th (k is an integer satisfying 1≦k≦n) switch unit and the power supply; and
a control unit which performs an on/off control of the 1st to n-th switch units and sequentially switches a switch unit to be turned on at every predetermined time.

2. The solar simulator according to claim 1, wherein the 1st to n-th switch units include power semiconductors, respectively, and a voltage applied to gate electrodes of input MOSFETs of the power semiconductors is variable.

3. The solar simulator according to claim 2, wherein the power semiconductors are insulated gate bipolar transistors.

4. A solar simulator comprises:
a flash lamp which radiates light to a solar battery module;
a power supply which supplies a current to the flash lamp;
a plurality of switch units connected in parallel which cause a current to be supplied to the flash lamp when turned on and cause a current to the flash lamp to be shut off when turned off;
a ballast resistor interposed between a common connection point of the plurality of switch units and the power supply; and
a control unit which performs an on/off control for causing the plurality of switch units to be turned on and off at a different timing.

5. The solar simulator according to claim 4, wherein the control unit turns on a second switch unit at a predetermined time before a time at which a first switch unit is turned off.

6. The solar simulator according to claim 1, wherein the control unit controls a voltage of the power supply based on irradiance and a radiation time of light of the flash lamp, a lamp current, and transient heat temperature increase values of power semiconductors included in the switch units.
